(19) United States
(12) Patent Application Publication
(10) Pub. No.: US 2025/0087728 A1
(43) Pub. Date: Mar. 13, 2025

(54) METHOD FOR OPERATING A FUEL CELL SYSTEM, AND A CONTROL DEVICE

(71) Applicant: Robert Bosch GmbH, Stuttgart (DE)

(72) Inventors: Christopher Bruns, Sindelfingen (DE); Kristoffer Kantschar, Ludwigsburg (DE); Timo Bosch, Renningen (DE); Tobias Falkenau, Esslingen (DE)

(21) Appl. No.: 18/728,930

(22) PCT Filed: Dec. 28, 2022
(86) PCT No.: PCT/EP2022/087950

§ 371 Date: Jul. 15, 2024

(30) Foreign Application Priority Data
Jan. 20, 2022 (DE) 10 2022 200 635.6

(51) Int. Cl. H01M 8/04119; H01M 8/0438; H01M 8/04858

(52) U.S. Cl. CPC H01M 8/04164; H01M 8/04388; H01M 8/04947

(57) ABSTRACT

The invention relates to a method for operating a fuel cell system (1), comprising a fuel cell stack (2), in which method anode gas coming from the fuel cell stack (2) is recirculated via an anode circuit (3) using an electrical recirculation pump (4) integrated in the anode circuit (3), wherein liquid water contained in the recirculated anode gas is separated using a water separator (5) integrated in the anode circuit (3), and wherein water separated using the water separator (5) is collected in a container (6) which is emptied periodically by opening an electromagnetically actuatable drain valve (7). According to the invention, the drive power of the recirculation pump (4) is monitored and, if a sudden increase in drive power is detected, the drain valve (7) is opened.

The invention also relates to a control device (8) for carrying out steps of the method according to the invention.

### BACKGROUND

The invention relates to a method for operating a fuel cell system. Furthermore, a control device for executing the method or individual method steps is proposed.

Hydrogen-based fuel cell systems are considered to be the mobility concept of the future, as they essentially only emit water and enable fast refueling times. The hydrogen is stored in a tank that is carried on board a vehicle. The oxygen also required is taken from the ambient air. Hydrogen and oxygen react in a fuel cell to form water or water vapor. At the same time, electrical power is generated through electrochemical conversion. To increase output, a plurality of individual cells are stacked and connected to form a fuel cell stack.

During operation of a fuel cell system, the hydrogen is fed to an anode of a fuel cell stack. As the anode gas coming from the fuel cell stack still contains hydrogen, it is recirculated via an anode circuit. The recirculation can be achieved passively using a jet pump and/or actively using a recirculation pump that is actuated electrically or by an electric motor. By using a recirculation pump, an acceleration of the gas flow is achieved, which ensures a homogeneous and sufficient hydrogen supply.

Recirculated anode gas is made up of various components, wherein the main components are hydrogen, nitrogen, and water vapor. Water vapor can condense, so that liquid water can also be present in addition to water vapor. As excessive liquid water content can damage the fuel cells, liquid water is separated using a water separator and collected in a container. If the container is full, the container can be emptied by opening a switching valve, the so-called “drain valve”. The drain valve can be opened after a predetermined cycle frequency, wherein there is a risk that if it is opened too often or for too long, not only liquid water but also anode gas will be removed from the system. To prevent this, the fill level in the container can be monitored using a fill level sensor. If the sensor signals that the container is full, the drain valve is opened.

However, the integration of level sensors can lead to leakage problems. Furthermore, level sensors are expensive to purchase. The integration of the sensors requires additional effort, so that the costs increase further.

The invention is therefore concerned with the task of specifying a method for operating a fuel cell system that enables the drain valve to be controlled even without a level sensor.

In order to solve this problem, the method according to the disclosure is proposed. Advantageous embodiments of the invention can be gathered from the dependent claims. In addition, a control device for executing the method or individual steps of the method is specified.

The invention is not limited to mobile fuel cell systems, but can also be applied to stationary fuel cell systems.

### SUMMARY

A method for operating a fuel cell system comprising a fuel cell stack is proposed. In the process, anode gas coming from the fuel cell stack is recirculated via an anode circuit using an electrical recirculation pump integrated into the anode circuit. Liquid water contained in the recirculated anode gas is separated using a water separator integrated into the anode circuit. Water separated using the water separator is collected in a container which is emptied periodically by opening an electromagnetically actuatable drain valve. According to the invention, the drive power of the recirculation pump is monitored and, if a sudden increase in drive power is detected, the drain valve is opened.

If the water separator container is full so that no more liquid water can be absorbed, the liquid water content in the anode gas increases. The liquid water enters the recirculation pump via the gas flow, where it hits a rotating rotor and slows it down. The resulting loss of speed is compensated for by the pump control, which leads to a sudden increase in drive power. A sudden increase in the drive power of the recirculation pump is therefore an indication that the water separator container is full. By opening the drain valve, the container can be emptied so that the liquid water content drops again. This also ensures that the fuel cells in the fuel cell stack are not damaged.

The drive power required by the recirculation pump to adjust the speed depends essentially on the viscosity of the anode gas and thus on its composition, in particular on the current ratio of its main components hydrogen, nitrogen, and water vapor. The composition changes continuously during operation of a fuel cell system, but very slowly, so that only moderate changes in the drive power occur under the assumption of stationary speed operation. The evaluation of the drive power therefore clearly shows a sudden change, so that the proposed method is reliable. This in turn makes it possible to dispense with a level sensor. Moreover, the evaluation of the drive power can provide information about the prevailing concentration ratios in the anode gas.

Preferably, a sudden increase in the drive power of the recirculation pump is detected if the increase is significantly higher than continuous fluctuations in the drive power, which are attributable to a varying anode gas composition. A significantly higher increase is usually not attributable to a continuously changing anode gas composition, but to an unacceptably high liquid water content, which is attributable to a full, overflowing container or a poorly separating water separator. By initiating a drainage process, irreversible damage to the fuel cells can be avoided.

It is also preferable that the drive power of the recirculation pump is continuously recorded. This means that even slow changes in the drive power are recorded so that they can be used as a reference value. In this way, sudden increases are reliably detected. In addition, the continuously recorded drive power can be evaluated with regard to the current composition of the anode gas.

According to a preferred embodiment of the invention, the drive power is transmitted from a control unit of the recirculation pump to a control device of the fuel cell system by means of a communication protocol. The drive power is thus evaluated by a higher-level control device, preferably a control device that is also used to control the drain valve, so that the drain valve can be controlled or opened directly depending on the result of the evaluation.

The proposed method does not require any additional sensor technology, making it simple and cost-effective to implement. By dispensing with additional sensor technology, the process also proves to be less prone to errors, particularly with regard to leaks.

In a further development of the invention, it is proposed that dynamic changes in the speed of the recirculation pump are detected and considered when the method is carried out. This is because these can also lead to a significant increase in drive power and can be falsely recognized as a droplet impact.

Furthermore, it is proposed that if there is no sudden increase in the drive power of the recirculation pump, the drain valve is opened at regular intervals in accordance with control logic. This ensures that the water separator container is emptied regularly. If regular emptying is not sufficient, the proposed method prevents an unacceptably high liquid water content in the anode gas.

The control logic required for regular emptying is preferably stored in the control device, which is used to control the drain valve and evaluate the drive power of the recirculation pump. In this way, when determining the emptying interval, an emptying that has already been carried out according to the method of the invention can be taken into account. For example, the period until the next emptying can be adjusted.

In addition, a control device that is configured so as to carry out steps of the method according to the invention is proposed. In particular, the control device can be used to evaluate the drive power of the recirculation pump. The drive power is made available to the control device for this purpose, preferably by a control unit of the recirculation pump, and also preferably by means of a suitable communication protocol. If a sudden increase in drive power is detected, the drain valve can then be activated using the control device to open it.

### BRIEF DESCRIPTION OF THE DRAWINGS

The method according to the invention and its advantages are explained in more detail below with reference to the accompanying drawings. Shown are:

FIG. 1 a schematic illustration of a fuel cell system which can be operated according to the method according to the invention, and

FIG. 2 diagrams illustrating a) the drive power of the recirculation pump, b) the droplet impact, and c) the control of the drain valve, in each case over the time t.

### DETAILED DESCRIPTION

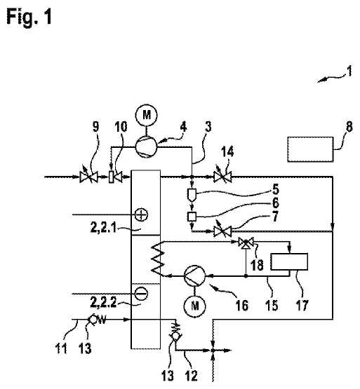

FIG. 1 shows a fuel cell system 1, comprising a fuel cell stack 2 with an anode 2.1 and a cathode 2.2. An anode gas is fed to the anode 2.1 via an anode circuit 3, wherein this is fresh hydrogen, which is introduced into the anode circuit 3 using a metering valve 9, as well as recirculated anode gas, as this still contains hydrogen residues. The recirculation is achieved passively using a jet pump 10 and actively using a recirculation pump 4. The latter is actuated electrically or by an electric motor. The cathode 2.2 is supplied with air via a supply air path 11. The exhaust air coming from the fuel cell stack 2 is discharged via an exhaust air path 12. The supply air path 11 and the exhaust air path 12 can be separated from the fuel cell stack 2 by means of shut-off valves 13.

In addition to electrical power, the electrochemical reaction in the fuel cells of the fuel cell stack 2 also generates heat and water or water vapor. To dissipate the heat, a cooling circuit 15 with a coolant pump 16 is connected to the fuel cell stack 2. A vehicle radiator 17 is integrated into the cooling circuit 15, which can be bypassed depending on the shift position of a bypass valve 18.

Water that accumulates as a product or condensed water vapor can be removed using a water separator 5 arranged on the anode side. The separated water is first collected in a container 6. When this is full, the container 6 can be emptied by opening a drain valve 7. Alternatively or additionally, the drain valve 7 can be opened at regular time intervals in accordance with a control logic stored in a control device 8.

As recirculated anode gas is enriched with nitrogen over time, which is diffused from the cathode side to the anode side, the anode circuit 3 is purged periodically. A further valve is provided on the anode side for this purpose, the so-called purge valve 14. Anode gas can be removed from the anode circuit 3 via the open purge valve 14. The removed quantity can then be replaced with fresh hydrogen via the metering valve 9.

Nitrogen and liquid water are removed from the anode gas to protect the fuel cells. This measure also ensures that the fuel cells of the fuel cell stack 2 are supplied with sufficient hydrogen.

In order to reliably prevent an excessive amount of liquid water in the anode gas, the drive power of the recirculation pump 4 can be monitored and evaluated using the control device 8. If the control device 8 detects a sudden increase in the drive power, this is usually attributable to a full container 6 and an excessively high liquid water content in the anode gas. In this case, there is a risk that the fuel cells of the fuel cell stack 2 will be damaged. To counteract this, the drain valve 7 can be activated and opened using the control device 8. The container 6 is then emptied in a targeted manner so that the water separator 5 is functional again.

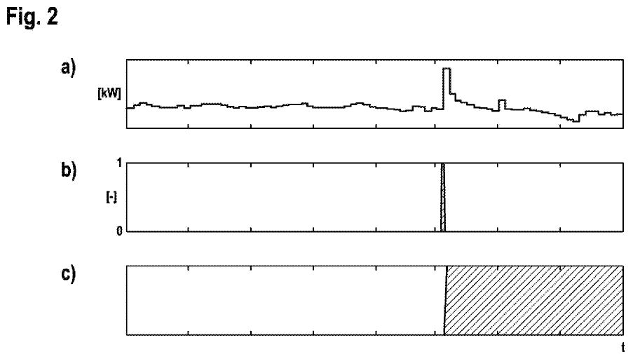

FIG. 2 shows an example of the drive power of a recirculation pump 4 over time t (see diagram a)). A sudden increase in the drive power after about two-thirds of the time t is clearly recognizable. This increase is attributable to a specific event, which is referred to here as a droplet impact (see diagram b)). Droplet impact occurs in the recirculation pump 4 when water droplets contained in the anode gas hit a rotating rotor of the recirculation pump 4 due to an excessively high liquid water content. This slows down the rotor. To compensate for this, the control unit of the recirculation pump 4 increases the drive power, and does so abruptly. This can therefore be regarded as an indication of a full container 6. According to the method according to the invention, the drain valve 7 is therefore opened when a sudden increase in drive power is detected (see diagram c)).

1. A method for operating a fuel cell system (1), comprising a fuel cell stack (2), in which method anode gas coming from the fuel cell stack (2) is recirculated via an anode circuit (3) using an electrical recirculation pump (4) integrated in the anode circuit (3), wherein liquid water contained in the recirculated anode gas is separated using a water separator (5) integrated in the anode circuit (3), and wherein water separated using the water separator (5) is collected in a container (6) which is emptied periodically by opening an electromagnetically actuatable drain valve (7),
wherein a drive power of the recirculation pump (4) is monitored and, when a sudden increase in drive power is detected, the drain valve (7) is opened.

2. The method according to claim 1,
wherein a sudden increase in the drive power of the recirculation pump (4) is detected when the increase is higher than continuous fluctuations in the drive power, which are attributable to a varying anode gas composition.

3. The method according to claim 1,
wherein the drive power of the recirculation pump (4) is continuously recorded.

4. A method according to claim 1,
wherein the drive power is transmitted from a control unit of the recirculation pump (4) to a control device (8) of the fuel cell system (1) according to a communication protocol.

5. A method according to claim 1,
wherein dynamic changes in the speed of the recirculation pump (4) are detected and considered.

6. A method according to claim 1,
wherein if there is no sudden increase in the drive power of the recirculation pump (4), the drain valve (7) is opened at regular intervals in accordance with control logic stored in the control device (8).

7. A control device (8) configured to operating a fuel cell system (1) that includes a fuel cell stack (2), in which anode gas coming from the fuel cell stack (2) is recirculated via an anode circuit (3) using an electrical recirculation pump (4) integrated in the anode circuit (3), wherein liquid water contained in the recirculated anode gas is separated using a water separator (5) integrated in the anode circuit (3), and wherein water separated using the water separator (5) is collected in a container (6) which is emptied periodically by opening an electromagnetically actuatable drain valve (7), by
monitoring a drive power of the recirculation pump (4) and, when a sudden increase in drive power is detected, opening the drain valve (7).
